(19) United States
(12) Patent Application Publication
(10) Pub. No.: US 2002/0085464 A1
(43) Pub. Date: Jul. 4, 2002

(54) Optical disk drive, and a lens-cleaning device and method therefor

(76) Inventor: Akira Mashimo, Tokorozawa-shi (JP)

Correspondence Address: Michael P. Dunnam, Esq., WOODCOCK WASHBURN LLP, 46th Floor, One Liberty Place, Philadelphia, PA, 19103, US

(21) Appl. No.: 10/008,672

(22) Filed: Dec. 7, 2001

(30) Foreign Application Priority Data
Dec. 28, 2000 (JP) 2000-402720

(51) Int. Cl. G11B 7/00

(52) U.S. Cl. 369/53.2; 369/53.37; 369/71

(57) ABSTRACT

A cleaning disk cartridge for cleaning the objective of an optical system in the transducer assembly of a DVD-RAM drive. The cartridge has a cleaning disk which is semirotatably received in a cartridge housing and which is bristled all over one major surface thereof. The cleaning disk has a clearance hole formed centrally therein for loosely receiving the drive spindle of the DVD-RAM drive. The clearance is such that the cleaning disk is left unchucked in the data transfer position, permitting the disk drive motor to run unloaded. The consequent ovespeeding of the motor enables the system controller to know that the cleaning disk cartridge, not a DVD-RAM cartridge, is loaded. The transducer is subsequently shuttled with the objective in sliding contact with the bristles of the stationary cleaning disk. The cleaning disk may be manually turned relative to the cartridge housing for use of successive different parts of its bristled surface for cleaning. An additional embodiment is disclosed.

### BACKGROUND OF THE INVENTION

This invention relates to a method of, and device for, cleaning the objective of an optical system built into the optoelectric transducer assembly of an apparatus for data transfer with a rotating optical disk through the medium of a light beam. The invention also pertains to an optical disk apparatus well adapted for use in combination with the cleaning device for automatically cleaning the objective.

The so-called cleaning disk has been known and used extensively for cleaning the objective of the transducer in optical disk apparatus such as CD players, CD-ROM drives, and so forth. Shaped and sized like the standard optical disk, the cleaning disk is bristled at its surface portion in the neighborhood of where the table of contents are recorded on the optical disk. As is well known, the optical disk apparatus is preprogrammed to read the prerecorded table of contents of each optical disk immediately after the disk is loaded therein. Therefore, traveling radially of the disk for reading the table of contents when the cleaning disk is loaded, too, the transducer has its objective cleaned by the bristles on the rotating cleaning disk.

There are some problems left unsolved with the cleaning disk of the above prior art design. First, covering a limited surface part of the disk, the bristles are easy to be stained and worn out, losing its cleaning power in comparatively short periods of time.

Another problem, perhaps potentially much more serious and far-reaching than the first, arises from the fact that the disk is driven at speeds several times higher than the standard audio CD speed in today's optical disk apparatus other than audio CD players, as typified by CD-ROM drives. When used for cleaning the transducer objective in such high-speed disk drives, the prior art cleaning disk in such high-speed rotation can be damaging to the objective or even to the entire transducer assembly which carries such delicate mechanisms as focusing and tracking actuators in addition to the transducer itself.

### SUMMARY OF THE INVENTION

The present invention aims at cleaning the objective of the transducer assembly in optical disk apparatus without the risk of doing harm to the transducer assembly.

Another object of the invention is to extend the useful life of lens-cleaning device of the kind defined.

Still another object of the invention is to automate the lens-cleaning process to such an extent that all that the operator is required to do is to insert the cleaning device into the optical disk apparatus.

Briefly stated in one aspect thereof, the present invention concerns a lens-cleaning device for an apparatus for data transfer with a rotating optical disk. The data transfer apparatus is of the type having drive means including a drive spindle to be engaged in a center hole in the optical disk, chuck means or hold means for holding the optical disk to the drive means, and a transducer movable substantially radially of the optical disk for data transfer therewith, the transducer having an objective through which a beam of light is thrown to the optical disk.

For cleaning the objective of the transducer, the lens-cleaning device comprises a cleaner carrier shaped more or less like an optical disk in order to be replaceably loaded in the data transfer apparatus and placed in the data transfer position therein. The cleaner carrier carries cleaner means, such for example as bristles, for frictional engagement with the objective of the transducer. Formed in the cleaner carrier is a clearance opening for receiving the drive spindle of the data transfer apparatus with clearance when the lens-cleaning device is in the data transfer position. The clearance is such that the lens-cleaning device is left unengaged by the chuck means and, in consequence, not driven by the drive means in the data transfer position.

Such being the improved construction of the lens-cleaning device according to the invention, it will be seen that the lens-cleaning device when in the data transfer position permits the drive means to overspeed by being not loaded thereby. From this overspeeding it is ascertainable that the lens-cleaning device, not the optical disk, lies in the data transfer position. The lens-cleaning device stays out of rotation during the subsequent process of lens cleaning, the objective being cleaned by shuttling the transducer substantially radially of the cleaning disk, with the objective in sliding contact with the cleaner means.

Thus the lens is cleaned by the travel of the transducer, not by the rotation of the cleaning disk, so that there is practically no danger of the transducer being ruined by the relative motion between them. Preferably, as in one embodiment to be disclosed subsequently, the cleaning disk is bristled all over one major surface thereof. Since only a radial portion of the bristled surface is used for lens cleaning at one time, the cleaning disk is to be manually turned a required angle relative to the cartridge housing every now and then so that successive different parts of the bristled surface may be put to cleaning for a longer useful life of the cleaning device.

Stated in other aspects thereof, the invention provides a data transfer apparatus suitable for use with the lens-cleaning device summarized above, and a method of cleaning the objective of the apparatus by the cleaning device. The data transfer apparatus can be of generally known construction except for its system controller, which is preprogrammed for implementation of the cleaning method. The cleaning method may be summarized as follows:

The lens-cleaning device according to the invention is first loaded in the data transfer apparatus thereby causing the cleaning device to be conventionally transported to and placed in the data transfer position. Unlike the optical disk, however, the cleaning disk is not chucked in this data transfer position by reason of its large clearance opening set forth above. After subsequently setting the disk drive motor into rotation, it is ascertained whether the motor is running at normal speed by being loaded by an optical disk or is overspeeding by being not loaded by the cleaning disk. The motor is set out of rotation if it proves overspeeding. Then the objective is cleaned by shuttling the transducer, with the objective in sliding contact with the cleaner means of the cleaning disk.

All that the user needs to do for lens cleaning is to insert the cleaning disk into the data transfer apparatus. Preferably, the apparatus may be preprogrammed so as to eject the cleaning disk after the transducer has been shuttled a desired number of times.

The above and other objects, features and advantages of this invention will become more apparent, and the invention itself will best be understood, from a study of the following description and appended claims, with reference had to the attached drawings showing the preferred embodiments of the invention.

### BRIEF DESCRIPTION OF THE DRAWINGS

FIG. 1 is a plan view of the lens-cleaning disk cartridge embodying the principles of this invention;

FIG. 2 is a section through the lens-cleaning disk cartridge of FIG. 1, taken along the line II-II therein;

FIG. 3 is a fragmentary, enlarged sectional view of the cleaning disk of the disk cartridge of FIGS. 1 and 2, the cleaning disk being herein shown loaded in the data transfer position within an optical disk drive for use therewith, loosely receiving the drive spindle in its clearance opening and having its bristles in sliding engagement with the objective of the optoelectric transducer assembly;

FIG. 4 is a combined pictorial and block-diagrammatic illustration of the optical disk drive for use with the disk cartridge of FIGS. 1 and 2;

FIG. 5 is a block diagram equivalently depicting part of the system controller of the FIG. 4 optical disk drive;

FIG. 6 is a flowchart of the lens-cleaning program introduced into the system controller of FIG. 5; and

FIG. 7 is a plan view of another preferred form of lens-cleaning disk cartridge according to the invention.

### DESCRIPTION OF THE PREFERRED EMBODIMENTS

### General

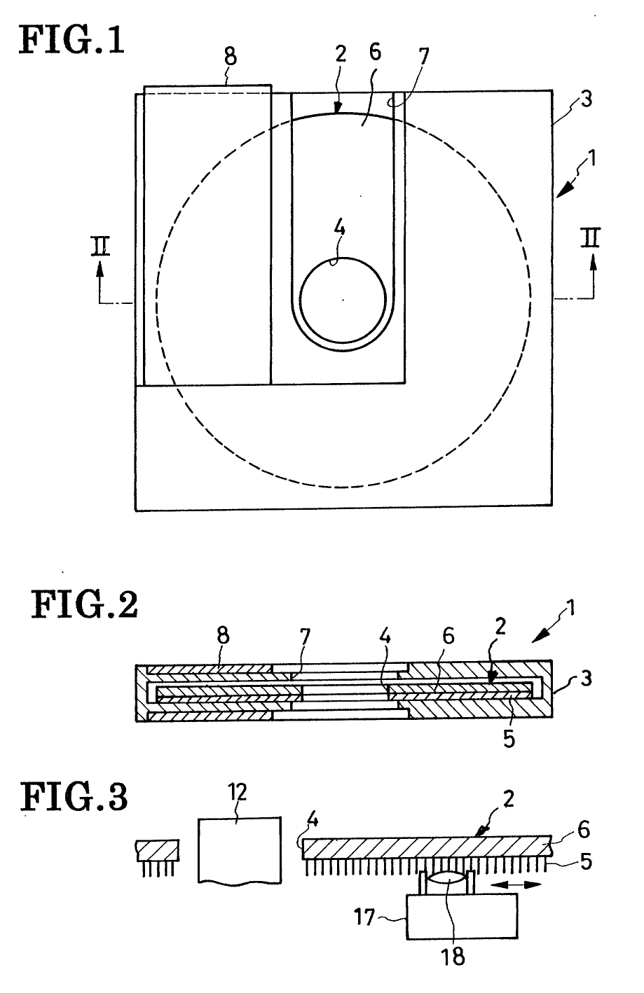

The invention will be described hereinbelow as applied specifically for cleaning the objective of an optical system built into the optoelectric transducer assembly of an apparatus for data transfer with a DVD-RAM in cartridge form. That apparatus will be hereinafter referred to as DVD-RAM drive, optical disk drive, or simply as disk drive. For particular use with the DVD-RAM drive, the cleaning device according to the invention takes the form of a cleaning cartridge pictured in FIGS. 1 and 2. FIG. 3 shows the cleaning disk itself of the cleaning cartridge in enlarged, fragmentary form, together with the objective of the disk drive transducer assembly being cleaned.

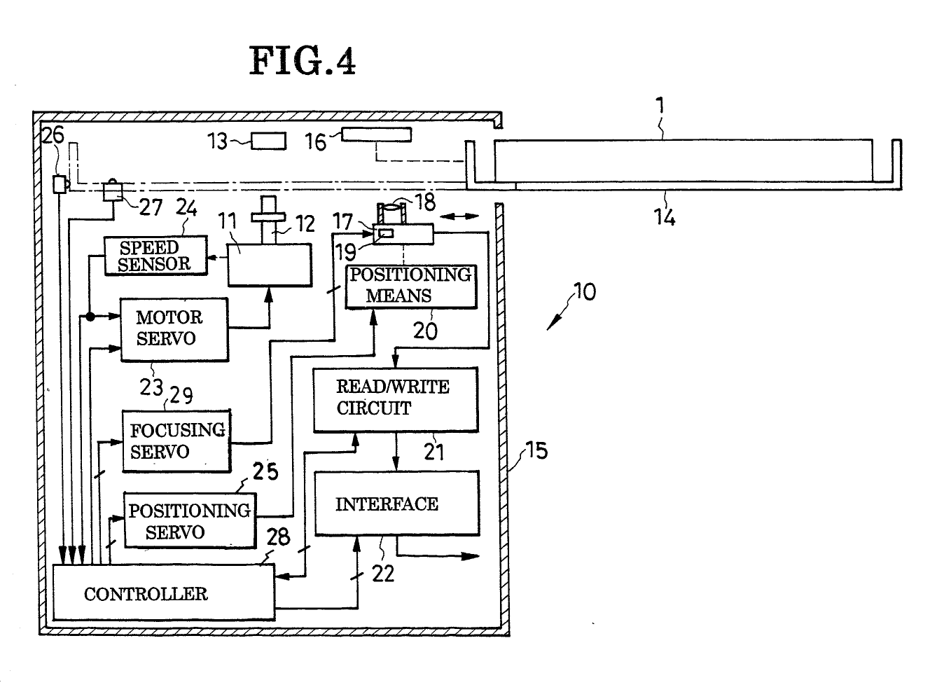

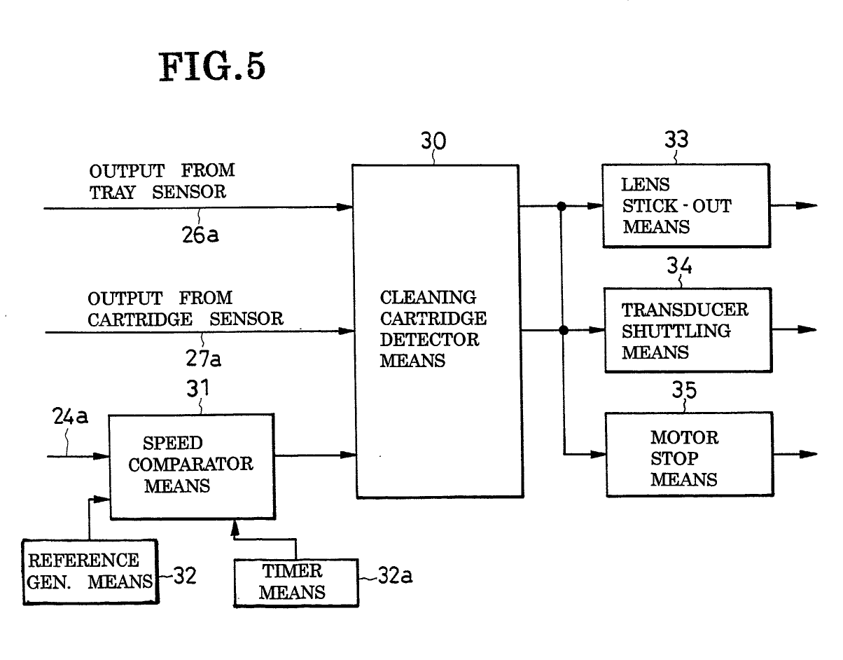

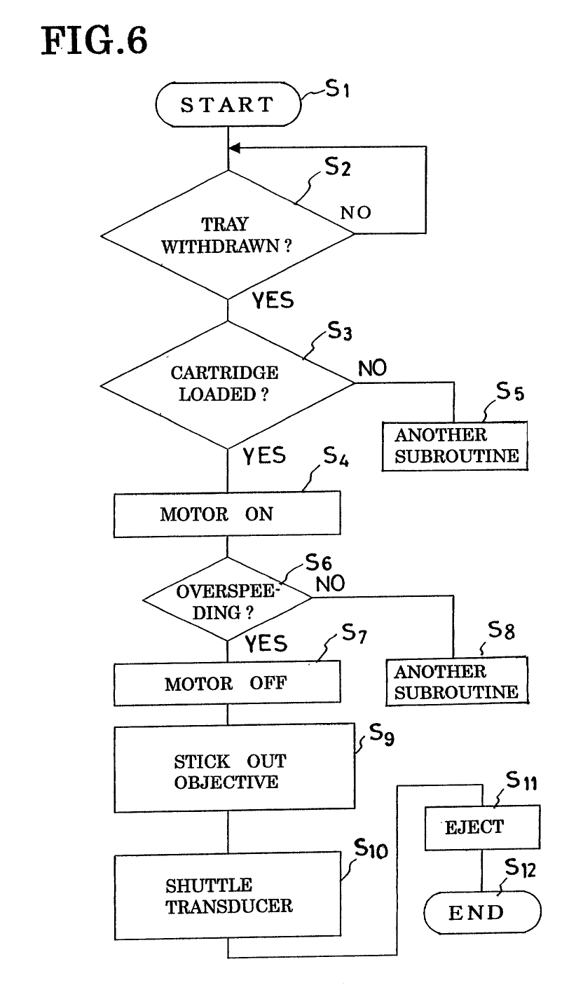

As illustrated in FIG. 4, the DVD-RAM drive for use with the cleaning cartridge of this invention can be of largely conventional make except for the system controller shown in detail in FIG. 5. The system controller is factory preprogrammed for automatically cleaning the transducer objective by the cleaning cartridge upon manual insertion thereof into the disk drive. The cleaning subroutine flowcharted in FIG. 6 is meant to illustrate the cleaning method proposed by this invention.

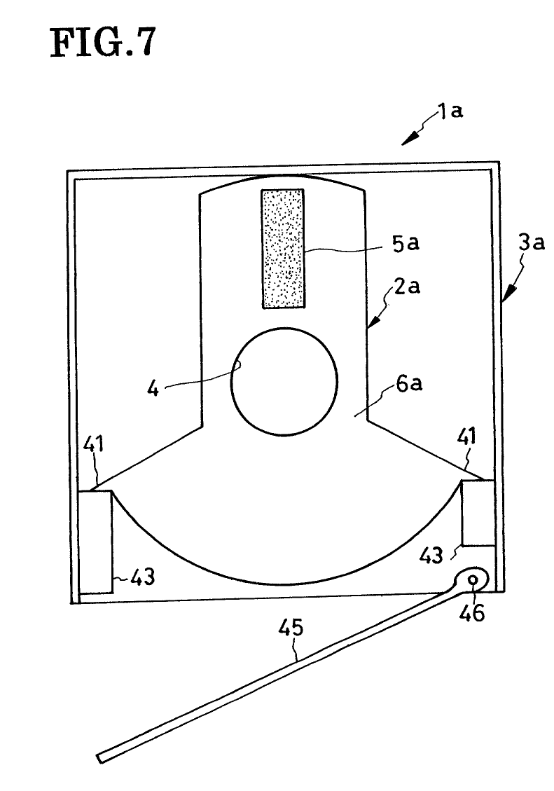

Hereinafter in this specification the cleaning disk cartridge, the DVD-RAM drive for use therewith, and the cleaning method according to the invention will be detailed in that order and under the separate headings. A disclosure of the alternate embodiment in FIG. 7 will follow such detailed description.

### Lens-Cleaning Disk Cartridge

Generally labeled 1 in FIGS. 1 and 2, the lens-cleaning disk cartridge has a cleaning disk 2 enveloped in a protective housing 3 therefore. The cleaning disk 2 has cleaner means such as bristles 5 implanted in one surface of a disklike cleaner carrier 6. The cleaner carrier 6 is of approximately the same diameter and thickness as the standard DVD-RAM disk. However, the center hole 4 in the cleaner carrier 6 is larger than that of the standard optical disk, as will be explained in more detail subsequently. The cartridge housing 3 is also of approximately the same shape and size as that of the standard DVD-RAM cartridge. The lens-cleaning disk cartridge 1 may therefore be loaded in, and unloaded from, the DVD-RAM drive of FIG. 4 just like any of interchangeable DVD-RAM cartridges for use therewith.

As pictured in more detail in FIG. 3, the cleaning disk 2 has one of the opposite major surfaces of the cleaner carrier 6 covered almost completely with the bristles 5. Preferably, the bristles 5 are of polyester erected on the cleaner carrier surface as with an ultraviolet-setting resin, with or without a silicone coating for higher dust collecting capability. As desired, the bristles 5 may be impregnated with alcohol just before use, for wet cleaning.

With continued reference to FIG. 3 the cleaning disk 2 has the center hole, or clearance opening, 4 formed centrally in the cleaner carrier 6 for receiving the drive spindle 12 of the DVD-RAM drive with substantial clearance. The clearance is sufficiently large to prevent the cleaning disk 2 from being chucked when the disk is placed in a data transfer position within the disk drive, as will become more apparent from the subsequent description of the disk drive.

Referring back to FIGS. 1 and 2, the housing 3 of the cleaning disk cartridge 1 has windows 7 formed in register in its pair of walls on opposite sides of the cleaning disk 2, as in the housing of the standard optical disk. The windows 7 expose the clearance opening 4 for receiving the drive spindle and chucking means of the disk drive, and a radial portion of the cleaning disk 2 for brushing the transducer objective. A U-shaped, spring-loaded sliding shutter 8 is mounted astride one edge of the housing 3 for opening and closing the windows 7.

In cases where one complete surface of the cleaning disk 2 is bristled, as set forth above, this disk should be semirotatable relative to the housing 3; that is, the disk should normally stay in the same angular position relative to the housing but turn within the housing when manually forced to. The complete bristled surface of the disk will then be used for cleaning, by manually turning the disk to expose successive different parts of the surface. The semirotatable mounting of the cleaning disk may be accomplished either by making the disk sufficiently thick to be frictionally engaged by the housing 3 or by providing some additional engagement means, either frictional or positive, between disk and housing.

The complete cleaning cartridge 1 may be discarded when all the bristled surface of the cleaning disk 1 is used up. Preferably, however, the cartridge 1 may be made openable for replacement of the worn cleaning disk only.

### Optical Disk Drive

Generally designated 10 in FIG. 4, the DVD-RAM drive for use with the cleaning disk cartridge 1 has a disk drive motor 11 coupled directly to a drive spindle 12 which is to be loosely received in the clearance opening 4 of the cleaning disk 2 when the cleaning disk cartridge 1 is brought to the data transfer position within the apparatus. A chuck 13 is for firmly holding an optical disk, not shown, in the data transfer position in cooperation with the drive spindle 12. The optical disk is rotatably engaged in a data transfer position in driven relationship to the drive means. The cleaning disk 2 according to the invention is not engaged, however, by the chuck 13 as hold means since the clearance opening 4 therein is sufficiently large to prevent the chuck from engaging the disk.

Shown at 14 carrying the cleaning disk cartridge 1 is a tray which is coupled to an ejector mechanism or a loading mechanism 16 of any known or suitable design for carrying the cleaning disk cartridge, and of course a DVD-RAM cartridge for use with this disk drive, between the two positions indicated in FIG. 4. The tray 14 is depicted by the solid lines in a load/unload position, in which the tray is pulled out the casing 15 of the disk drive 10 to permit the cleaning disk cartridge 1, and the unshown DVD-RAM cartridge, to be loaded on and unloaded from the disk. The other position, in which the tray is outlined by the broken lines, the noted data transfer position in which the DVD-RAM cartridge makes data transfer with the optoelectric transducer assembly 17 and in which the cleaning disk cartridge 1 cleans the objective 18 of the transducer assembly.

The transducer assembly 17 can be of any known or suitable construction capable of throwing a beam of light to the optical disk, and receiving the reflection of the beam therefrom, through the object lens or the objective 18. The beam reflection is translated into an electric signal indicative of the data read on the disk. Further, irradiating the disk with the beam of write intensity, the transducer assembly writes data on the disk. A focusing actuator 19 is conventionally mounted to the transducer assembly 17 for keeping the beam focused on the disk surface by moving the objective 18 toward and away therefrom. A transducer positioning mechanism 20 is also conventional in the art, positioning the transducer assembly 17 in any desired track position on the disk by moving the transducer assembly radially of the disk.

The electric data signal from the transducer assembly 17 is directed into a read/write circuit 21, where the signal is reshaped into a binary pulse signal, demodulated, and freed from errors, if any, preparatory to delivery to an external system such as a personal computer via an interface 22. The read/write circuit 21 also includes a modulator for modulating the write beam with data to be written on the disk.

The disk drive motor 11 is provided with a speed control servo circuit 23 and a speed sensor 24 for rotation at desired speed. A focusing servo circuit 29 is connected to the noted focusing actuator 19 of the transducer assembly 17 in order to keep the light beam focused on the disk. A tracking servo circuit, not shown, is conventionally connected to a tracking actuator, also not shown, which is mounted to the transducer assembly 17 and which is coupled to the objective 18 for keeping the beam spot in centerline alignment with the data track on the disk. A positioning servo circuit 25, also conventional in the art, is connected to the transducer positioning mechanism 20. A tray sensor 26 detects the tray 14 when the latter comes to the data transfer position within the disk drive casing 15. A cartridge sensor 27 detects the DVD-RAM cartridge, as well as the cleaning disk cartridge 1 according to the invention, when the cartridge is carried to the data transfer position by the tray 14.

At 28 in FIG. 4 is shown a system controller in the form of a microcomputer including a central processor unit, a read-only memory, and a random-access memory for controlling the DVD-RAM drive 10. The system controller 28 is connected to all of the read/write circuit 21, interface circuit 22, motor servo circuit 23, speed sensor 24, positioning servo circuit 25, tray sensor 26, cartridge sensor 27, and focusing servo circuit 29. The firmware introduced into the system controller 28 is designed to control not only the normal reading and writing operations of the DVD-RAM drive 10 but also the lens cleaning operation with the cleaning cartridge 1 according to the invention.

As far as its lens-cleaning control function is concerned, the system controller 28 may be envisaged as equivalently comprising the means indicated in block form in FIG. 5. A cleaning cartridge detector means 30 is for ascertaining whether the cleaning disk cartridge 1, not an optical disk cartridge, is loaded and placed in the data transfer position within the disk drive. In order to enable the cleaning cartridge detector means 30 to ascertain this fact, there are connected to the means 30 the output line 26a of the tray sensor 26, FIG. 4, the output line 27a of the cartridge sensor 27, and, via a speed comparator means 31, the output line 24a of the disk drive motor speed sensor 24.

Additionally connected to the speed comparator means 31 are a reference generator means 32 for providing a normal motor speed limit signal to be compared with the actual motor speed signal, and a timer means 32a for measuring a prescribed length of time from the moment of commencement of disk drive motor rotation. The normal speed limit signal represents a motor speed somewhat above that upon lapse of the prescribed length of time from the beginning of motor rotation when it is driving an optical disk. The speed comparator means 31 compares the rotational speed of the disk drive motor 11 with the speed limit upon lapse of the prescribed length of time following the start of motor rotation, and informs the cleaning cartridge detector means 30 of whether the disk drive motor is overspeeding or not.

Since the cleaning disk 2 with its large clearance opening 4 is not chucked in the data transfer position, the disk drive motor 11 will rotate unloaded when set in motion following the loading of the cleaning disk. The motor will therefore accelerate more rapidly than when driving an optical disk. The cleaning cartridge detector means 30 is enabled to determine that the cleaning cartridge 1 is being driven when the motor 11 is overspeeding, and that an optical disk is being driven when the motor is not. For still more reliable discrimination between the two types of disk cartridges, the motor speed may be compared with several different reference speeds at several different moments in time.

Also included in the system controller 28, and all connected to the cleaning cartridge detector means 30, are a lens stick-out means 33, a transducer shuttling means 34, and a disk drive motor stop means 35. The lens stick-out means 33 puts out a signal for causing the focusing actuator 19, FIG. 4, of the transducer assembly 17 to thrust the objective 18 toward the disk surface when the cleaning cartridge detector means 30 determines as above that the cleaning cartridge 1 is loaded. The output signal of the lens stick-out means 33 is delivered to the focusing servo circuit 29. The transducer shuttling means 34 also responds to the output from the cleaning cartridge detector means 30 upon its determination that the cleaning cartridge I is loaded. The response is such that the transducer assembly 17 is caused to reciprocate several times radially of the cleaning disk 2 in order to have its objective 18, which is being held in its most protuberant position, brushed by the cleaning disk bristles 5 as pictured in FIG. 3. The output from the transducer shuttling means 34 is sent to the transducer positioning servo circuit 25.

The disk drive motor 11 need not rotate after the cleaning cartridge 1 has been detected as such. The motor stop means 35 is therefore connected to the motor speed servo circuit 23 for setting the motor 11 out of rotation when the cleaning cartridge detector means 30 detects the cleaning cartridge 1.

### Lens-Cleaning Method

The firmware introduced into the system controller 28 is such that the DVD-RAM drive 10, FIG. 4, is automatically triggered into the series of actions flowcharted in FIG. 6. Starting at S₁, the program asks at S₂ whether the tray 14 is withdrawn into the drive casing 15 or not. If the tray sensor 26 indicates that it is, then at the next node S₃ it is ascertained if the tray is loaded with a cartridge, either the cleaning disk cartridge according to the invention or the standard optical disk cartridge. The disk drive motor 11 is set into rotation at the next block S₄ if the cartridge sensor 27 indicates the presence of a cartridge. If it does not, the program goes to another regular subroutine at S₅.

Then at the node S₆ the disk drive motor speed sensor 24 is relied upon to discriminate between the cleaning disk cartridge and the optical disk cartridge. As has been stated with reference to FIG. 5, the motor speed upon lapse of a prescribed length of time following the start of motor rotation at S₄ is compared with the upper limit of the normal speed range in the case where an optical disk cartridge is loaded. The motor will be loaded by the optical disk cartridge if it is loaded, and unloaded if the cleaning disk cartridge is loaded. Therefore, if the motor is overspeeding, the cleaning cartridge detector means 30 determines that the cleaning disk cartridge is loaded, and causes the motor to be set out of rotation at the next block S₇. If the motor is not overspeeding, on the other hand, then it is driving an optical disk cartridge, so that a different subroutine is invoked at S₈.

Then, according to the next block S₉, the focusing actuator 19, FIG. 4, is energized to cause the objective 18 to jut out into frictional engagement with the bristles 5, FIG. 3, on the cleaning disk 6. Then the transducer assembly 17 is shuttled a preassigned number of times at the block S₁₀, thereby having its objective 18 brushed and cleaned by the cleaning disk 2. Then the cleaning cartridge is ejected at the block S₁₁, thereby letting the user know the completion of lens cleaning. The lens-cleaning subroutine comes to an end at S₁₂.

If left in the same angular position relative to the cartridge housing 3, the cleaning disk 2 would have the same part of its bristled surface used for cleaning. Only such part of bristles would sooner or later be worn out and become unfit for cleaning. It is therefore recommended that the cleaning disk 2 be manually turned relative to the cartridge housing 3 by an appropriate angle at appropriate time intervals so that different parts of the bristles may be put to successive use. Used in this manner, one cleaning disk cartridge will stay fit for cleaning for a remarkably greater length of time than heretofore.

The complete cleaning disk cartridge need not be discarded, either, when the cleaning disk is used up, if only the cartridge housing 3 is made openable. An unused cleaning disk may then be inserted in the housing 3 in substitution for the used one, thereby avoiding wasteful use of the cartridge housing.

### Alternate Embodiment

In FIG. 7 is shown an alternate cleaning cartridge 1a for use with the DVD-RAM drive 10, FIG. 4, in substitution for the first disclosed cleaning cartridge 1. The alternate cleaning cartridge 1a is a combination of a cleaning semidisk 2a and a housing 3a therefor. The cartridge housing 3a is divided flatwise into a pair of halves, one of which is not shown to reveal the inner details. The cleaning semidisk 2a, which comprises a cleaner carrier 6a and cleaner means 5a thereon, is so named because the shape of the cleaner carrier resembles a T-shaped part of a disk formed by cutting off two symmetrical parts thereof. Formed centrally in this cleaner carrier 6a is the clearance opening 4 sufficiently large to keep the semidisk 2a from being chucked in the data transfer position within the FIG. 4 disk drive 10. The cleaner means 5a takes the form of bristles planed on that part of the cleaner carrier 6a which is exposed from the cartridge housing 3a through an equivalence of the window 7, FIG. 1, therein.

The cleaner carrier 6a is formed to include a pair of locking lugs 41 extending in opposite directions therefrom. When the cleaning semidisk 2a is fully received in the cartridge housing 3a as portrayed in FIG. 7, the locking lugs 41 are engaged by a pair of ledges 43 formed symmetrically in the inside surfaces of the pair of opposed edges of the cartridge housing. Thus is the cleaning semidisk 2a positively retained within the cartridge housing 3a and locked in such an angular position relative to the same that the cleaner bristles 5a are exposed through the window in the cartridge housing.

At 45 is seen a lid pivotally pinned at 46 to the cartridge housing 3a. This pivoted lid is to be opened, as in this figure, for loading or unloading the cleaning semidisk 2a into and from the cartridge housing 3a. It is understood that the cleaning semidisk 2a is sufficiently flexible to permit the locking lugs 41 to ride over the lugs 43 and engage, or disengage, the ledges 43 while forced into and out of the cartridge housing 3a.

It will now be apparent that the alternate cleaning cartridge 1a is designed for easy replacement of the cleaning semidisk 2a. The cleaning cartridge 1a can be put to use with the DVD-RAM drive 10 of FIGS. 4 and 5 construction just like the first disclosed cleaning cartridge 1, for cleaning the transducer objective 18 according to the cleaning program of FIG. 6.

### Possible Modifications

Notwithstanding the foregoing detailed disclosure it is not desired that the present invention be limited by the exact showing of the drawings or the description thereof. A variety of modifications of the illustrated embodiments will suggest themselves to the specialists to conform to each specific application of the invention or to design preferences. The following is a brief list of such possible modifications which are all considered to fall within the purview of this invention:

1. The provision of the cartridge housing 3 or 3a is not an essential feature of the invention; that is, only the cleaning disk 2 or semidisk 2a may be put to use with CD or CD-ROM drives, CDs and CD-ROMs themselves being not in cartridge form. The bare cleaning disk or semidisk may then be affixed to the disk tray as by adhesive tape and removed upon completion of cleaning.

2. During cleaning according to the FIG. 6 program, the display of the computer system interfaced with the FIG. 4 disk drive may be made to indicate the loading of the cleaning cartridge, the progress of cleaning, and/or the completion of cleaning.

3. Despite its name the cleaning disk could take variously shapes other than those depicted in FIGS. 1 and 7.

4. Bristles or other cleaning means could be provided on both surfaces of the cleaner carrier.

What is claimed is:

1. A lens-cleaning device for an apparatus for data transfer with a rotating optical disk, the data transfer apparatus having drive means including a drive spindle to be engaged in a center hole in the optical disk, chuck means for holding the optical disk to the drive means, and a transducer movable substantially radially of the optical disk for data transfer therewith, the transducer having an objective through which a beam of light is thrown to the optical disk, the lens-cleaning device being for cleaning the objective of the transducer and comprising:
(a) a cleaner carrier to be replaceably loaded in the data transfer apparatus and placed in the data transfer position therein like the optical disk;
(b) cleaner means carried by the cleaner carrier so as to be frictionally engaged by the objective of the transducer when the cleaner carrier is in the data transfer position;
(c) there being a clearance opening formed in the cleaner carrier to receive the drive spindle of the data transfer apparatus with clearance when the cleaner carrier is in the data transfer position, the clearance opening being sufficiently large to prevent the lens-cleaning device from being engaged by the chuck means, and hence from being driven by the drive means, when the cleaner carrier is in the data transfer position;
(d) whereby the lens-cleaning device when in the data transfer position permits the drive means to overspeed by being not loaded by the lens-cleaning device, from which fact it is ascertainable that the lens-cleaning device, not the optical disk, lies in the data transfer position, and whereby the lens-cleaning device stays out of rotation in the data transfer position, cleaning the objective of the transducer by relative movement thereof with the objective in sliding contact with the cleaner means.

2. The lens-cleaning device of claim 1 wherein the cleaner carrier is in the form of a disk of approximately the same size and shape as the optical disk.

3. The lens-cleaning device of claim 1 wherein the data transfer apparatus is for use with an optical disk cartridge having the optical disk rotatably enveloped in a protective housing therefor, and wherein the lens-cleaning device is provided in the form of a cleaning cartridge, with the cleaner carrier, together with the cleaner means thereon, enveloped in a protective housing of approximately the same shape and size as the housing of the optical disk cartridge, the housing of the cleaning cartridge having a window formed therein to expose at least part of the cleaner means on the cleaner carrier.

4. The lens-cleaning device of claim 3 wherein the cleaner carrier is in the shape of a disk having at least one of opposite major surfaces thereof substantially completely covered by the cleaner means, and wherein the cleaner carrier together with the cleaner means thereon is half fixed to the housing, being capable of forced angular displacement relative to the housing to expose successive different parts of the cleaner means through the window in the housing.

5. The lens-cleaning device of claim 3 wherein the cleaner carrier has part of a surface thereof covered by the cleaner means, wherein the cleaner carrier together with the cleaner means thereon is nonrotatably received in the housing of the cleaning cartridge, and wherein the housing of the cleaner cartridge has an openable lid to replacement of the cleaner carrier.

6. In combination with a lens-cleaning device having a cleaner carrier carrying cleaner means and having a clearance opening formed therein, an apparatus for data transfer with a rotating optical disk, the data transfer apparatus comprising:
(a) loading means for carrying either of the optical disk and the lens-cleaning device between an eject position and a data transfer position;
(b) drive means including a drive spindle to be engaged in a center hole in the optical disk when the optical disk is carried by the loading means to the data transfer position, and, with clearance, in the clearance opening in the cleaner carrier of the lens-cleaning device when the latter is carried by the loading means to the data transfer position;
(c) chuck means for holding the optical disk to the drive means, the clearance opening in the cleaner carrier of the lens-cleaning device being sufficiently large to prevent the cleaner carrier from being engaged by the chuck means, and hence from being driven by the drive means, when the lens-cleaning device is in the data transfer position;
(d) a transducer movable substantially radially of the optical disk for data transfer therewith, the transducer having an objective through which a beam of light is thrown to the optical disk, the objective being capable of frictional engagement with the cleaner means carried by the cleaner carrier of the lens-cleaning device when the latter is in the data transfer position;
(e) transducer positioning means for moving the transducer substantially radially of the optical disk; and
(f) a controller for ascertaining whether it is the optical disk or the lens-cleaning device that lies in the data transfer position, on the basis of whether the drive means is overspeeding by being not loaded by the lens-cleaning device, and, if it is the lens-cleaning device, for causing the transducer to move with the objective in frictional engagement with the cleaner means on the cleaner carrier of the lens-cleaning device.

7. The data transfer apparatus of claim 6 wherein the controller comprises:
(a) cleaning device detector means for ascertaining the fact that the lens-cleaning device is in the data transfer position;
(b) lens stick-out means connected to the cleaning device detector means for causing the objective of the transducer to move into frictional engagement with the cleaner means of the lens-cleaning device when the latter is found to be in the data transfer position; and
(c) transducer shuttling means connected to the cleaning device detector means for causing the transducer to shuttle with the objective in sliding contact with the cleaner means of the lens-cleaning device.

8. In an apparatus for data transfer with a rotating optical disk, the data transfer apparatus having a drive motor coupled to a drive spindle which is to be engaged in a center hole in the optical disk when the latter is in a data transfer position, chuck means for holding the optical disk to the drive motor, and a transducer movable substantially radially of the optical disk for data transfer therewith, the transducer having an objective through which a beam of light is thrown to the optical disk, a method of cleaning the objective of the transducer which comprises:
(a) providing a lens-cleaning device having a cleaner carrier which carries cleaner means and which is to be replaceably loaded in the data transfer apparatus and positioned in the data transfer position therein like the optical disk;
(b) loading the lens-cleaning device in the data transfer apparatus and thereby causing the same to be placed in the data transfer position;
(c) setting the drive motor out of rotation; and
(d) cleaning the objective of the transducer by shuttling the transducer with the objective in sliding contact with the cleaner means of the lens-cleaning device, the lens-cleaning device being out of rotation during the cleaning of the objective.

9. The cleaning method of claim 8 which further comprises sticking out the objective of the transducer toward the lens-cleaning device into frictional engagement with the cleaner means thereof preparatory to shuttling the transducer.
